(19) United States
(12) Patent Application Publication
(10) Pub. No.: US 2026/0048655 A1
(43) Pub. Date: Feb. 19, 2026

(54) METHOD AND APPARATUS TO MECHANICALLY LOCK TWO OR MORE ELECTRIC MOTORS FOR INCREASED VEHICLE TRACTION

(71) Applicant: FCA US LLC, Auburn Hills, MI (US)

(72) Inventor: Andrew Johnson, Auburn Hills, MI (US)

(21) Appl. No.: 18/801,973

(22) Filed: Aug. 13, 2024

(51) Int. Cl. B60K 23/00; B60K 1/02; B60K 7/00; B60K 17/04; B60K 17/16; B60K 17/354; B60K 17/356; B60K 35/28

(52) U.S. Cl. CPC B60K 23/00; B60K 1/02; B60K 7/0007; B60K 17/043; B60K 17/165; B60K 17/354; B60K 17/356; B60K 35/28; B60K 2007/0061; B60K 2360/172

(57) ABSTRACT

An electrified powertrain for a vehicle includes first and second electric motors, first and second gearbox assemblies, a coupling assembly and a controller. The first electric motor includes a first stator, a first rotor and a first output shaft. The second electric motor includes a second stator, a second rotor and a second output shaft. The first gearbox assembly operably connects the first output shaft with a first drive axle that drives a first drive wheel. The second gearbox assembly operably connects the second output shaft with a second drive axle that drives a second drive wheel. The coupling assembly has a first stub shaft, a second stub shaft, a collar and an actuator. The coupling assembly is movable between an unlocked position wherein the first and second stub shafts are disconnected and a locked position wherein the first and second stub shafts are fixed for concurrent rotation.

### FIELD

The present application relates generally to electrified powertrains and, more particularly, to a coupling assembly that mechanically couples drive shafts to multiple electric motors for concurrent rotation on an electrified vehicle.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. Some electrified vehicles are configured with more than one electric motor. In some driving conditions one drive wheel may be experience wheel slip. Current solutions include electronic devices that can detect a wheel slip and make adjustments to route power to a drive wheel that has traction. Traditional axle locker mechanisms cannot be incorporated on vehicles having electric motors on each drive wheels. Accordingly, while such arrangements do work well for their intended purpose, there is a desire for improvement in the relevant art.

### SUMMARY

In accordance with one example aspect of the invention, an electrified powertrain for a vehicle includes first and second electric motors, first and second gearbox assemblies, a coupling assembly and a controller. The first electric motor includes a first stator, a first rotor and a first output shaft. The second electric motor includes a second stator, a second rotor and a second output shaft. The first gearbox assembly operably connects the first output shaft with a first drive axle that drives a first drive wheel. The second gearbox assembly operably connects the second output shaft with a second drive axle that drives a second drive wheel. The coupling assembly has a first stub shaft, a second stub shaft, a collar and an actuator. The coupling assembly is movable between an unlocked position wherein the first and second stub shafts are disconnected and a locked position wherein the first and second stub shafts are fixed for concurrent rotation. The controller is configured to: receive a lock signal from a human machine interface (HMI) indicative of a desire to lock the coupling assembly; and responsive to the lock signal, command the actuator to move the collar thereby moving the coupling assembly from the unlocked position to the locked position, wherein in the locked position, the first and second output shafts and first and second drive shafts are fixed for concurrent rotation by the coupling assembly.

In examples, the controller is further configured to: receive an unlock signal from the HMI indicative of a desire to unlock the coupling assembly; and responsive to the unlock signal, command the actuator to move the collar thereby moving the coupling assembly from the locked position to the unlocked position, wherein in the unlocked position, the first and second output shafts and first and second drive shafts are not fixed for concurrent rotation by the coupling assembly.

In addition to the foregoing, the controller is further configured to: receive sensor inputs indicative of vehicle conditions; determine, based on the vehicle conditions, whether transitioning to the locked position is permitted; and command the actuator to move the collar based on confirmation that the transitioning is permitted.

In addition to the foregoing, the vehicle conditions comprise wheel speeds of the first and second drive wheels and wherein the determination includes a comparison of the wheel speeds.

In addition to the foregoing, the controller is further configured to: display a message on the HMI indicative of a status of the coupling assembly.

In examples, the vehicle is a two-wheel drive vehicle.

In accordance with another example aspect of the invention, an electrified powertrain for a vehicle includes first and second electric motors, first and second gearbox assemblies, first and second coupling assemblies and a controller. The first electric motor includes a first stator, a first rotor and a first output shaft. The second electric motor includes a second stator, a second rotor and a second output shaft. The first gearbox assembly operably connects the first output shaft with a first drive axle that drives a first drive wheel and a second drive axle that drives a second drive wheel. The second gearbox assembly operably connects the second output shaft with a third drive axle that drives a third drive wheel and a fourth drive axle that drives a fourth drive wheel. The first coupling assembly has a first stub shaft, a second stub shaft, a first collar and a first actuator. The first coupling assembly is movable between an unlocked position wherein the first and second stub shafts are disconnected and a locked position wherein the first and second stub shafts are fixed for concurrent rotation.

The second coupling assembly has a third stub shaft, a fourth stub shaft, a second collar and a second actuator. The second coupling assembly is movable between an unlocked position wherein the third and fourth stub shafts are disconnected and a locked position wherein the third and fourth stub shafts are fixed for concurrent rotation.

The controller is configured to: receive a lock signal from a human machine interface (HMI) indicative of a desire to lock the first and second coupling assemblies; and responsive to the lock signal, command the first and second actuators to move the first and second collars thereby moving the first and second coupling assemblies from the unlocked position to the locked position, wherein in the locked position, the first and second output shafts and the first, second, third and fourth drive shafts are fixed for concurrent rotation by the first and second coupling assemblies.

In examples, the first gearbox includes a first differential assembly.

In addition to the foregoing, the second gearbox includes a second differential assembly

In addition to the foregoing, the controller is configured to: receive an unlock signal from the HMI indicative of a desire to unlock the first and second coupling assemblies; and responsive to the unlock signal, command the first and second actuators to move the first and second collars thereby moving the first and second coupling assemblies from the locked position to the unlocked position, wherein in the unlocked position, the first and second output shafts and first, second, third and fourth drive shafts are not fixed for concurrent rotation by the first and second coupling assemblies.

In addition to the foregoing, the controller is configured to: receive sensor inputs indicative of vehicle conditions; determine, based on the vehicle conditions, whether transitioning to the locked position is permitted; and command the first and second actuators to move the first and second collars based on confirmation that the transitioning is permitted.

In examples, the vehicle conditions comprise wheel speeds of at least one of the first and second drive wheels and at least one of the third and fourth drive wheels wherein the determination includes a comparison of the wheel speeds.

In examples, the vehicle is a four-wheel drive vehicle.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle drivetrain that incorporates two electric motors per drive axle, the drivetrain having a coupling assembly that mechanically couples drive shafts of the drive axle to the electric motors for concurrent rotation, the coupling assembly shown in an unlocked position in accordance with the principles of the present application;

FIG. 2 is a schematic diagram of the example electric vehicle drivetrain that incorporates two electric motors per drive axle of FIG. 1 and shown with the coupling assembly in a locked position in accordance with the principles of the present application; and

FIG. 3 is an exemplary method of locking the coupling assembly of FIGS. 1 and 2, in accordance with the principles of the present application;

FIG. 4 is an exemplary method of unlocking the coupling assembly of FIGS. 1 and 2, in accordance with the principles of the present application;

FIG. 5 is a schematic illustration of an example electric vehicle four wheel drive drivetrain that incorporates a first electric motor associated with a front drive axle and a second electric motor associated with a rear drive axle, the drivetrain having a coupling assembly that mechanically couples an axle shaft connected between a front gearbox associated with the front drive axle and a rear gearbox associated with the rear drive axle to the electric motors for concurrent rotation, the coupling assembly shown in an unlocked position in accordance with the principles of the present application;

FIG. 6 is a schematic illustration of an example electric vehicle four wheel drive drivetrain that incorporates a first electric motor associated with a front drive axle and a second electric motor associated with a rear drive axle, the coupling assembly shown in a locked position in accordance with principles of the present application;

FIG. 7 is an exemplary method of locking the coupling assembly of FIGS. 5 and 6, in accordance with the principles of the present application; and

FIG. 8 is an exemplary method of unlocking the coupling assembly of FIGS. 5 and 6, in accordance with the principles of the present application.

### DETAILED DESCRIPTION

As identified above, some electrified vehicles are configured with more than one electric motor. In some driving conditions one drive wheel may be experience wheel slip. Current solutions include electronic devices that can detect a wheel slip and make adjustments to route power to a drive wheel that has traction. Traditional axle locker mechanisms cannot be incorporated on vehicles having electric motors on each drive wheel. Currently available solutions to wheel slip include brake lock differential and traction control. Other methods to account for wheel slip on an electric vehicle having multiple motors include electronically controlling the individual motor speeds. A drawback of such electronic control is that they are largely reactive and do not engage until wheel slip occurs. In other words, wheel slip must first be detected for them to engage. Once engaged, such electronic control can provide improved vehicle traction, however, still allow some wheel slip.

According to the principles of the present application, systems and methods are described where a coupling assembly is configured on electrified vehicles having multiple electric motors to mechanically connect drive shafts. In one implementation, the coupling assembly mechanically couples left and right electric motors configured on respective left and right drive shafts of a drive axle. In another implementation, the coupling assembly mechanically couples a front to rear drive axle thereby fixing front and rear electric motors in a four-wheel-drive vehicle for concurrent rotation.

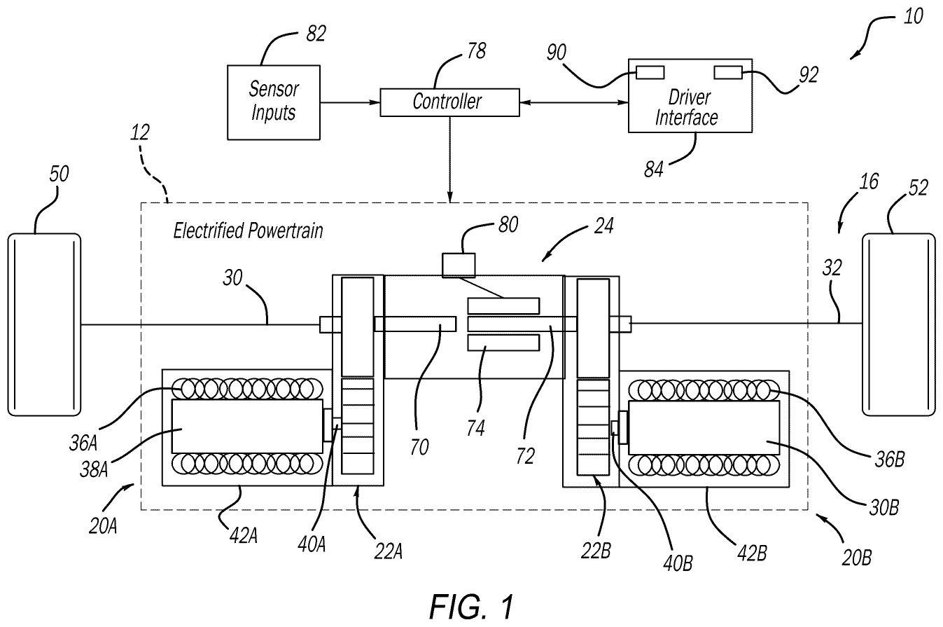

With initial reference to FIG. 1, a vehicle 10 is partially shown in accordance with the principles of the present disclosure. In the example embodiment, vehicle 10 includes an electrified powertrain 12 configured to generate and transfer drive torque to a driveline 16 for vehicle propulsion. The electrified powertrain 12 generally includes a first electric motor 20A, a first gearbox assembly 22A, a second electric motor 20B, a second gearbox assembly 22B and a coupling assembly 24.

In the example shown, the electrified powertrain 12 is configured for use on a rear axle of a two-wheel drive vehicle. It is appreciated however that the electrified powertrain 12 can be alternatively configured for use on a front axle of a two-wheel drive vehicle. In other examples the electrified powertrain can be provided on both of the front and rear axles for a four-wheel drive or all-wheel drive driveline vehicle.

The first electric motor 20A includes a first stator 36A, a first rotor 38A, and a first rotor output shaft 40A. The first stator 36A is fixed (e.g., to a housing 42A) and the first rotor 38A is configured to rotate relative to the stator 36A to drive the first rotor shaft 40A and thus a first drive axle 30 (e.g., half shaft) and therefore a first drive wheel 50. The electrified powertrain 12 further includes a second electric motor 20B and a second gearbox assembly 22B. The second electric motor 20B includes a second stator 36B, a second rotor 38B, and a second rotor output shaft 40B. The second stator 36B is fixed (e.g., to a housing 42B) and the second rotor 38B is configured to rotate relative to the stator 36B to drive the second rotor shaft 40B and thus a second drive axle 32 (e.g., half shaft) and therefore a second drive wheel 52.

The first electric motor 20A connects to the first drive axle 30 by way of the first gearbox assembly 22A. The second electric motor 20B connects to the second drive axle 32 by way of the second gearbox assembly 22B. The gearbox assemblies 22A and 22B can be configured in any manner that transfers rotatable motion from the output shafts 40A, 40B to the drive axles 30, 32. As such they may be configured as direct drive gearboxes or with any gear reduction or multiplication.

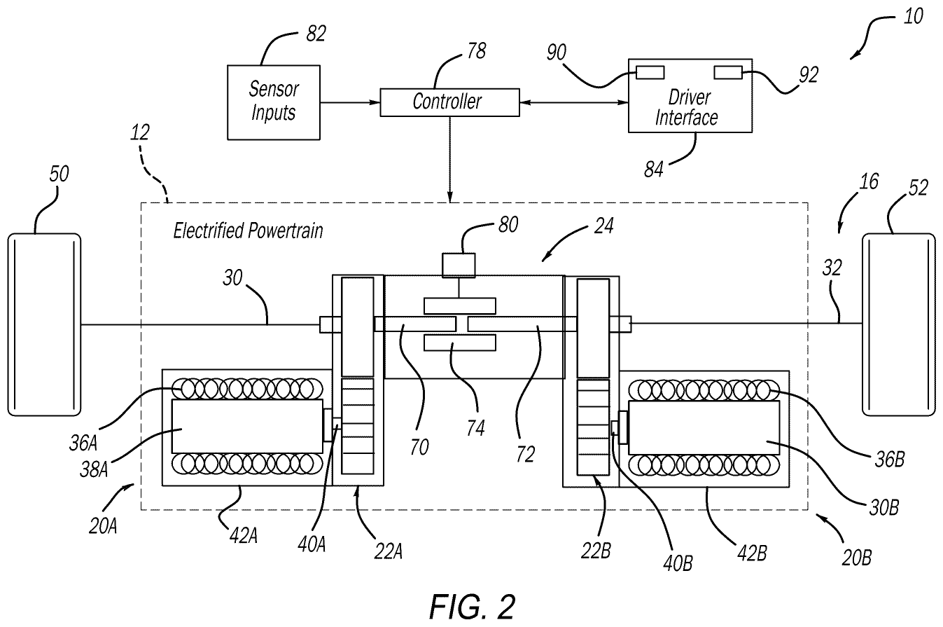

The coupling assembly 24 includes a first stub shaft 70, a second stub shaft 72, a shift fork or collar 74 and an actuator 80. As will be described herein, when it is desired to lock the drive axles 30 and 32, the actuator 80 is commanded to actuate the collar 74 to slide from an unlocked position shown in FIG. 1 to a locked position shown in FIG. 2. To move from the unlocked position to the locked position, the actuator 80 translates the collar 74 from the position shown in FIG. 1 to the position in FIG. 2 wherein the first and second stub shafts 70 and 72 are locked for concurrent rotation. Similarly, to move from the locked position to the unlocked position, the actuator translates the collar 74 to the position in FIG. 1 wherein the first and second stub shafts 70 and 72 are locked for concurrent rotation.

The electric vehicle 10 includes a controller 78 that communicates with the electrified powertrain 12 to control actuation of the coupling assembly 24. The controller 78 can determine when to command the coupling assembly 24 to move between the locked and unlocked positions based on various factors including signals from sensor inputs 82 and a driver interface 84. In examples, the driver interface 84 includes a human machine interface (HMI) 90 such as an infotainment cluster or other interface that receives inputs from a driver. The inputs can include a selection from the driver to lock or unlock the coupling assembly 24. The driver interface 84 can also include pedals 92 such as an accelerator pedal and a brake pedal. In one example, the controller 78 can receive a signal from the HMI 90 of the driver interface 84 indicative of a driver wishing to lock the coupling assembly 24. If the controller 78 determines that operating conditions are satisfied, the controller commands the actuator 80 to actuate the collar 74 from the unlocked position to the locked position. In another example, the controller 78 can receive a signal from the HMI 90 of the driver interface 84 indicative of a driver wishing to unlock the coupling assembly 24. If the controller 78 determines that operating conditions are satisfied, the controller commands the actuator 80 to actuate the collar 74 from the locked position to the unlocked position.

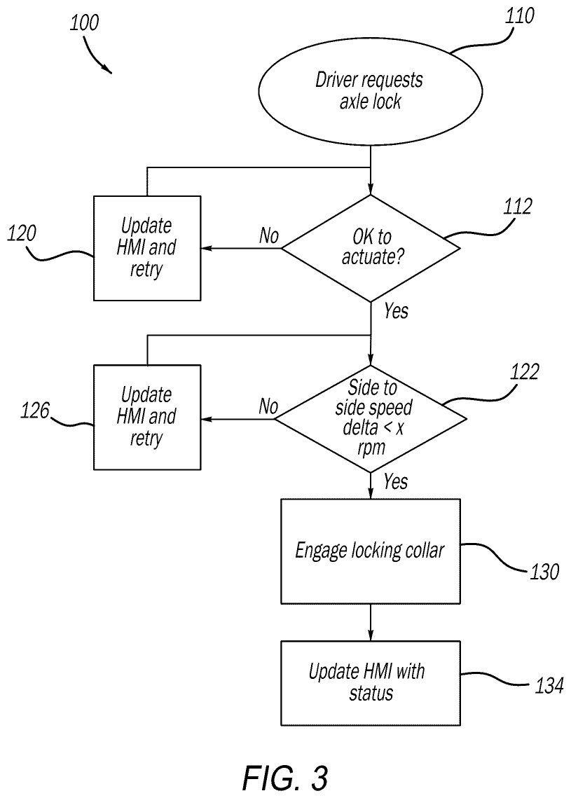

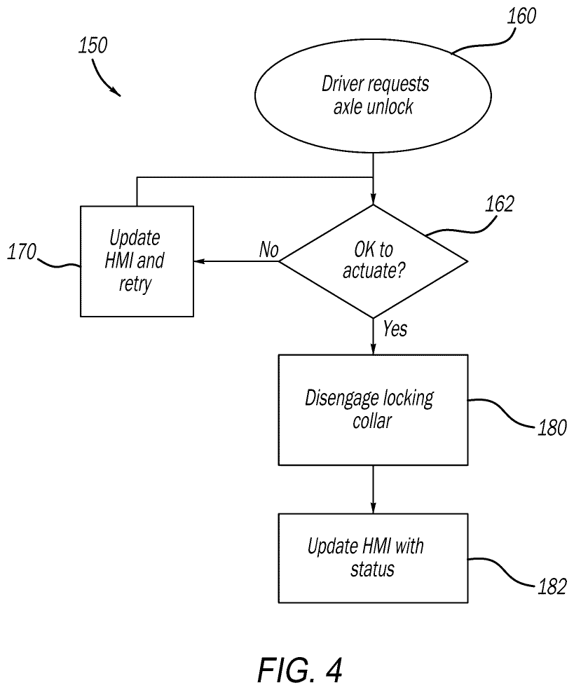

With continued reference to FIGS. 1 and 2 and additional reference to FIGS. 3 and 4, exemplary methods of locking and unlocking the coupling assembly 24 of FIGS. 1 and 2, in accordance with the principles of the present application will be described. A method for locking the coupling assembly 24 is shown in FIG. 3 and generally identified at reference numeral 100. At 110 a driver requests axle lock. As identified above, such request can be entered at the driver interface 84 (e.g., such as at the HMI 90). At 112 control determines whether conditions are suitable for locking the coupling assembly 24. Conditions can be indicative of various vehicle parameters (operating conditions including, but not limited to, vehicle speed, wheel speeds, detected surface conditions, vehicle component states, etc.) such as provided by sensor inputs 82.

If control determines conditions are satisfactory to actuate, control determines whether the side to side speed delta (e.g., wheel speeds of drive wheels 50 and 52) is less than a threshold delta revolutions per minute. If control determines that it is not OK to actuate the coupling assembly 24 at 112, control updates the HMI 90 (e.g., delivers a message to the driver indicative of the conditions not being suitable for actuating the coupling assembly 24) at 120. If control determines that the side to side speed delta is less than the threshold, the locking collar is actuated at 130 and the HMI 90 is updated with a message indicative of the successful locking of the coupling assembly 24. If control determines that the side to side speed delta is not less than the threshold, control updates the HMI 90 (e.g., delivers a message to the driver indicative of the conditions not being suitable for actuating the coupling assembly 24) at 134.

With particular reference to FIG. 4, a method for unlocking the coupling assembly 24 is shown in FIG. 4 and generally identified at reference numeral 150. At 160 a driver requests axle unlock. As identified above, such request can be entered at the driver interface 84 (e.g., such as at the HMI 90). At 162 control determines whether conditions are suitable for unlocking the coupling assembly 24. Conditions can be indicative of various vehicle parameters (operating conditions including, but not limited to, vehicle speed, wheel speeds, detected surface conditions, vehicle component states, etc.) such as provided by sensor inputs 82.

If control determines conditions are satisfactory to actuate, the locking collar 74 is actuated at 180 and the HMI 90 is updated with a message indicative of the successful unlocking of the coupling assembly 24 at 182. If control determines that it is not OK to actuate the coupling assembly 24 at 162, control updates the HMI 90 (e.g., delivers a message to the driver indicative of the conditions not being suitable for actuating the coupling assembly 24) at 170.

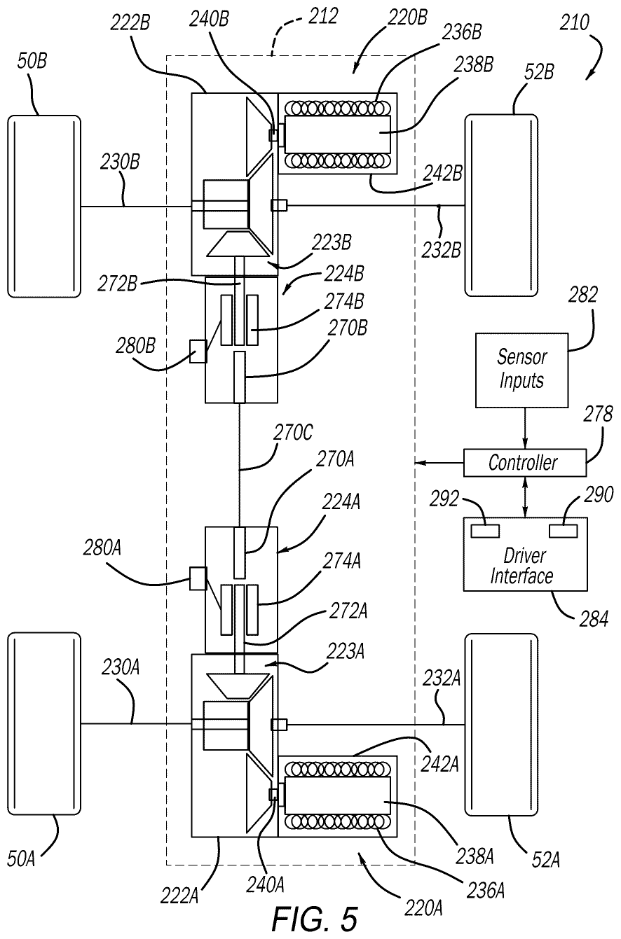

Turning now to FIG. 5, a vehicle 210 is partially shown in accordance with additional principles of the present disclosure. In the example embodiment, vehicle 210 includes an electrified powertrain 212 configured to generate and transfer drive torque to a driveline 216 for vehicle propulsion. The electrified powertrain 212 generally includes a first electric motor 220A, a first gearbox assembly 222A, a second electric motor 220B, a second gearbox assembly 222B, a first coupling assembly 224A, and a second coupling assembly 224B. In the example shown, the electrified powertrain 212 is configured for use on a four-wheel drive vehicle.

The first electric motor 220A includes a first stator 236A, a first rotor 238A, and a first rotor output shaft 240A. The first stator 236A is fixed (e.g., to a housing 242A) and the first rotor 238A is configured to rotate relative to the stator 236A to drive the first gearbox assembly 222A and a first differential 223A. Torque is transmitted through the first gearbox assembly 222A and the first differential 223A to the first and second drive axles 230A and 232A and therefore a first drive wheel 50A and a second drive wheel 52A.

The second electric motor 220B includes a second stator 36B, a second rotor 38B, and a second rotor output shaft 240B. The second stator 36B is fixed (e.g., to a housing 242B) and the second rotor 238B is configured to rotate relative to the stator 236B to drive the second gearbox assembly 222B and a second differential 223B. Torque is transmitted through the second gearbox assembly 222B and the differential 223B to the third and fourth drive axles 230B and 232B and therefore a third drive wheel 50B and a fourth drive wheel 52B.

The first electric motor 220A connects to the first and second drive axles 230A, 232A by way of the first gearbox assembly 222A and first differential 223A. The second electric motor 220B connects to the third and fourth drive axles 230B, 232B by way of the second gearbox assembly 222B and second differential 223B. The gearbox assemblies 222A and 222B can be configured in any manner that transfers rotatable motion from the output shafts 240A, 240B to the drive axles 230A, 232A, 230B, 232B. As such they may be configured as direct drive gearboxes or with any gear reduction or multiplication.

The first coupling assembly 224A includes a first stub shaft 270A, a second stub shaft 272A, a shift fork or collar 274A and an actuator 280A. The second coupling assembly 224B includes a third stub shaft 270B, a fourth stub shaft 272B, a shift fork or collar 274B and an actuator 280B. A connecting shaft 270C couples the shafts 270A and 270B.

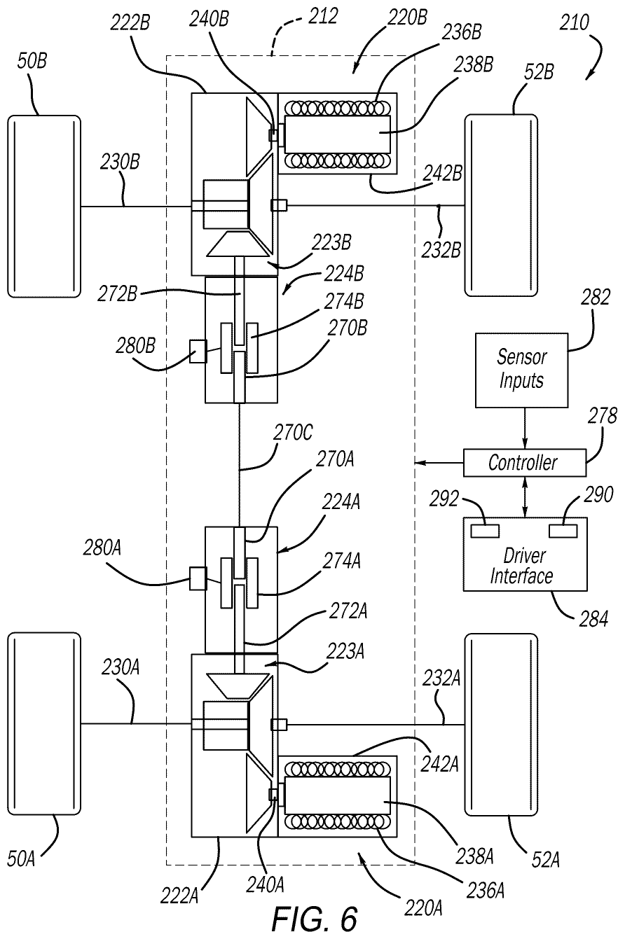

As will be described herein, when it is desired to lock the drive axles 230A, 232A, 230B, 232B, the actuators 280A, 280B are commanded to actuate the collars 274A, 274B to slide from an unlocked position shown in FIG. 5 to a locked position shown in FIG. 6. To move from the unlocked position to the locked position, the actuators 280A, 280B translate the collars 274A, 274B from the position shown in FIG. 5 to the position in FIG. 6 wherein the first and second stub shafts 270A and 272A are locked for concurrent rotation and the third and fourth stub shafts 270B and 272B are locked for concurrent rotation. Similarly, to move from the locked position to the unlocked position, the actuators 280A, 280B translate the collars 274A, 274B to the position in FIG. 5 wherein the first and second stub shafts 270A and 272A and the third and fourth stub shafts 270B, 272B are locked for concurrent rotation.

The electric vehicle 210 includes a controller 278 that communicates with the electrified powertrain 212 to control actuation of the coupling assemblies 224A, 224B. The controller 278 can determine when to command the coupling assemblies 224A, 224B to move between the locked and unlocked positions based on various factors including signals from sensor inputs 282 and a driver interface 284. In examples, the driver interface 284 includes a human machine interface 290 such as an infotainment cluster or other interface that receives inputs from a driver. The inputs can include a selection from the driver to lock or unlock the coupling assemblies 224A, 224B.

The driver interface 284 can also include pedals 292 such as an accelerator pedal and a brake pedal. In one example, the controller 278 can receive a signal from the HMI 290 of the driver interface 284 indicative of a driver wishing to lock the coupling assemblies 224A, 224B. If the controller 278 determines that operating conditions are satisfied, the controller 278 commands the actuators 280A, 280B to actuate the collars 274A, 274B from the unlocked position to the locked position. In another example, the controller 278 can receive a signal from the HMI 290 of the driver interface 284 indicative of a driver wishing to unlock the coupling assemblies 224A, 224B. If the controller 278 determines that operating conditions are satisfied, the controller 278 commands the actuators 280A, 280B to actuate the collars 274A, 274B from the locked position to the unlocked position.

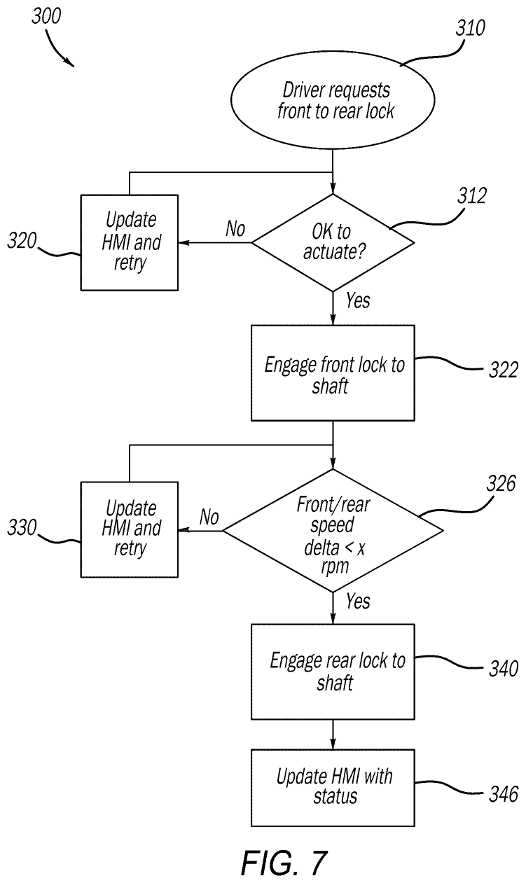

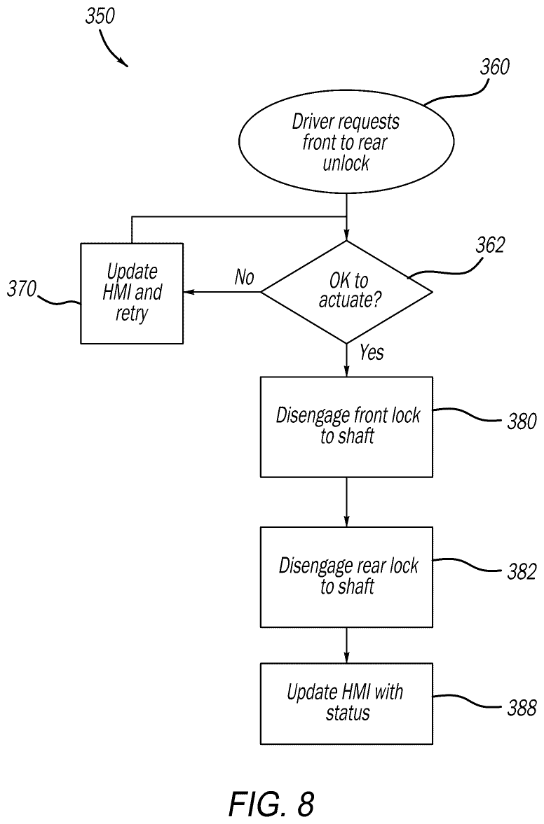

With continued reference to FIGS. 5 and 6 and additional reference to FIGS. 7 and 8, exemplary methods of locking and unlocking the coupling assembly 224A, 224B of FIGS. 5 and 6, in accordance with the principles of the present application will be described. A method for locking the coupling assembly 224A, 224B is shown in FIG. 7 and generally identified at reference numeral 300. At 310 a driver requests front to rear axle lock. As identified above, such request can be entered at the driver interface 284 (e.g., such as at the HMI 290). At 312 control determines whether conditions are suitable for locking the coupling assembly 224A, 224B. Conditions can be indicative of various vehicle parameters (operating conditions including, but not limited to, vehicle speed, wheel speeds, detected surface conditions, vehicle component states, etc.) such as provided by sensor inputs 282.

If control determines conditions are satisfactory to actuate, control engages front lock to shaft (coupling assembly 224B) at 322. At 322, the actuator 280B actuates the collar 274B to lock the shafts 270A, 272B. If control determines that it is not OK to actuate the coupling assembly 224B at 112, control updates the HMI 290 (e.g., delivers a message to the driver indicative of the conditions not being suitable for actuating the coupling assembly 224B) at 320.

At 326 control determines if the front to rear speed delta is less than a revolution per minute threshold. If control determines that the front to rear speed delta is less than the threshold, the locking collar 274A is actuated at 340 and the HMI 290 is updated with a message indicative of the successful locking of the coupling assembly 224A. If control determines that the front to rear speed delta is not less than the threshold, control updates the HMI 290 (e.g., delivers a message to the driver indicative of the conditions not being suitable for actuating the coupling assembly 24) at 330.

With particular reference to FIG. 8, a method for unlocking the coupling assembly 224A, 224B is shown and generally identified at reference numeral 350. At 360 a driver requests axle unlock. As identified above, such request can be entered at the driver interface 284 (e.g., such as at the HMI 290). At 362 control determines whether conditions are suitable for unlocking the coupling assembly 224A, 224B. Conditions can be indicative of various vehicle parameters (operating conditions including, but not limited to, vehicle speed, wheel speeds, detected surface conditions, vehicle component states, etc.) such as provided by sensor inputs 282.

If control determines conditions are satisfactory to actuate, the front locking collar 274B is actuated at 380, the rear locking collar 274A is actuated at 382 and the HMI 90 is updated with a message indicative of the successful unlocking of the coupling assembly 224A, 224B at 388. If control determines that it is not OK to actuate the coupling assembly 224A, 224B at 362, control updates the HMI 290 (e.g., delivers a message to the driver indicative of the conditions not being suitable for actuating the coupling assembly 224A, 224B) at 370.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electrified powertrain for a vehicle, the electrified powertrain comprising:
a first electric motor having a first stator, a first rotor and a first output shaft;
a first gearbox assembly that operably connects the first output shaft with a first drive axle that drives a first drive wheel;
a second electric motor having a second stator, a second rotor and a second output shaft;
a second gearbox assembly that operably connects the second output shaft with a second drive axle that drives a second drive wheel;
a coupling assembly having a first stub shaft, a second stub shaft, a collar and an actuator, the coupling assembly movable between an unlocked position wherein the first and second stub shafts are disconnected and a locked position wherein the first and second stub shafts are fixed for concurrent rotation; and
a controller that is configured to:
receive a lock signal from a human machine interface (HMI) indicative of a desire to lock the coupling assembly; and
responsive to the lock signal, command the actuator to move the collar thereby moving the coupling assembly from the unlocked position to the locked position, wherein in the locked position, the first and second output shafts and first and second drive shafts are fixed for concurrent rotation by the coupling assembly.

2. The electrified powertrain of claim 1, wherein the controller is further configured to:
receive an unlock signal from the HMI indicative of a desire to unlock the coupling assembly; and
responsive to the unlock signal, command the actuator to move the collar thereby moving the coupling assembly from the locked position to the unlocked position, wherein in the unlocked position, the first and second output shafts and first and second drive shafts are not fixed for concurrent rotation by the coupling assembly.

3. The electrified powertrain of claim 2, wherein the controller is further configured to:
receive sensor inputs indicative of vehicle conditions;
determine, based on the vehicle conditions, whether transitioning to the locked position is permitted; and
command the actuator to move the collar based on confirmation that the transitioning is permitted.

4. The electrified powertrain of claim 3, wherein the vehicle conditions comprise wheel speeds of the first and second drive wheels and wherein the determination includes a comparison of the wheel speeds.

5. The electrified powertrain of claim 4, wherein the controller is further configured to:
display a message on the HMI indicative of a status of the coupling assembly.

6. The electrified powertrain of claim 1, wherein the vehicle is a two-wheel drive vehicle.

7. An electrified powertrain for a vehicle, the electrified powertrain comprising:
a first electric motor having a first stator, a first rotor and a first output shaft;
a first gearbox assembly that operably connects the first output shaft with a first drive axle that drives a first drive wheel and a second drive axle that drives a second drive wheel;
a second electric motor having a second stator, a second rotor and a second output shaft;
a second gearbox assembly that operably connects the second output shaft with a third drive axle that drives a third drive wheel and a fourth drive axle that drive a fourth drive wheel;
a first coupling assembly having a first stub shaft, a second stub shaft, a first collar and a first actuator, the first coupling assembly movable between an unlocked position wherein the first and second stub shafts are disconnected and a locked position wherein the first and second stub shafts are fixed for concurrent rotation;
a second coupling assembly having a third stub shaft, a fourth stub shaft, a second collar and a second actuator, the second coupling assembly movable between an unlocked position wherein the third and fourth stub shafts are disconnected and a locked position wherein the third and fourth stub shafts are fixed for concurrent rotation; and
a controller that is configured to:
receive a lock signal from a human machine interface (HMI) indicative of a desire to lock the first and second coupling assemblies; and
responsive to the lock signal, command the first and second actuators to move the first and second collars thereby moving the first and second coupling assemblies from the unlocked position to the locked position, wherein in the locked position, the first and second output shafts and the first, second, third and fourth drive shafts are fixed for concurrent rotation by the first and second coupling assemblies.

8. The electrified powertrain of claim 7, wherein the first gearbox includes a first differential assembly.

9. The electrified powertrain of claim 8, wherein the second gearbox includes a second differential assembly.

10. The electrified powertrain of claim 7, wherein the controller is further configured to:
receive an unlock signal from the HMI indicative of a desire to unlock the first and second coupling assemblies; and
responsive to the unlock signal, command the first and second actuators to move the first and second collars thereby moving the first and second coupling assemblies from the locked position to the unlocked position, wherein in the unlocked position, the first and second output shafts and first, second, third and fourth drive shafts are not fixed for concurrent rotation by the first and second coupling assemblies.

11. The electrified powertrain of claim 9, wherein the controller is further configured to:
receive sensor inputs indicative of vehicle conditions;
determine, based on the vehicle conditions, whether transitioning to the locked position is permitted; and
command the first and second actuators to move the first and second collars based on confirmation that the transitioning is permitted.

12. The electrified powertrain of claim 11, wherein the vehicle conditions comprise wheel speeds of at least one of the first and second drive wheels and at least one of the third and fourth drive wheels wherein the determination includes a comparison of the wheel speeds.

13. The electrified powertrain of claim 12, wherein the controller is further configured to:
display a message on the HMI indicative of a status of the coupling assembly.

14. The electrified powertrain of claim 7, wherein the vehicle is a four-wheel drive vehicle.
